(19) United States
(12) Patent Application Publication
(10) Pub. No.: US 2013/0036625 A1
(43) Pub. Date: Feb. 14, 2013

(54) APPARATUS FOR DRYING PELLETS

(71) Applicant: Reinhardt-Karsten Muerb, Aschaffenburg (DE)

(72) Inventor: Reinhardt-Karsten Muerb, Aschaffenburg (DE)

(73) Assignee: AUTOMATIK PLASTICS MACHINERY GMBH, Grossostheim (DE)

(21) Appl. No.: 13/209,160

(22) Filed: Aug. 12, 2011

(30) Foreign Application Priority Data
Aug. 12, 2011 (DE) 102010034199.3

(51) Int. Cl. F26B 17/10; F26B 21/12

(52) U.S. Cl. 34/587; 34/591; 34/579; 34/565

(57) ABSTRACT

An apparatus for drying pellets having a housing and a rotor with rotor blades that is arranged in the housing such that it can be driven in rotation, having a dewatering region with at least one dewatering screen with dewatering screen openings that are smaller in size than the pellets, so that the process fluid can be separated from the pellets by means of passage from a screen front to a screen rear, wherein an auxiliary blower is arranged such that an auxiliary airflow from it is imparted in the direction of the pellets' primary direction of movement through the housing.

### CROSS REFERENCE TO RELATED APPLICATIONS

The present patent application claims priority to and the benefit of co-pending International Patent Application No. DE Application No. 102010034119.3, which was filed Aug. 12, 2010, entitled “APPARATUS FOR DRYING PELLETS.” This reference is incorporated in its entirety herein.

### FIELD

The present embodiments generally relate to an apparatus for drying pellets.

### BACKGROUND

A need exists for an apparatus for drying pellets that has an increased efficiency of drying.

A further need exists for an apparatus for drying pellets that requires less energy to operate a rotor thereof.

The present embodiments meet these needs.

### BRIEF DESCRIPTION OF THE DRAWINGS

The detailed description will be better understood in conjunction with the accompanying drawings as follows:

FIG. 1 is a schematic longitudinal cross-section of a portion of an apparatus for drying pellets according to one or more embodiments.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The apparatus for drying pellets can have a housing and a rotor located therein with rotor blades that can be driven in rotation, e.g. by a motor. The apparatus for drying pellets can also include a dewatering region. The dewatering region can have at least one dewatering screen.

The dewatering screen can have dewatering screen openings. The dewatering screen openings can be smaller in size than the pellets. Accordingly, the dewatering screens can allow process fluid, for example, water, to separate from the pellets by means of passage from a screen front to a screen rear. The terms “screen front” and “screen rear” here refer to the two sides of the screen surface, namely the side on which the material being screened remains, and the back of the screen surface in the region of which the process fluid and the objects, which is to say pellets, that are smaller than the screen openings arrive after passage through the screen openings.

The apparatus for drying pellets can have at least one auxiliary blower. The auxiliary blower can be arranged so auxiliary airflow from the auxiliary blow is imparted in the direction of the pellets' primary direction of motion through the housing. The airflow from the auxiliary blow allows the separation of pellets and process fluid to take place more effectively. In addition, the energy requirements for the drive of the rotor also can be reduced in a simple and economical manner, in particular in a compact housing of the apparatus according to the embodiments.

The rotor arrangement can correspond to the construction of a rotary dryer, such as is already used under the product name CENTRO from Automatik Plastics Machinery GmbH, for example.

The apparatus for drying pellets can utilize the forces or force components impressed on the pellets or process fluid, imparted by the rotor, so that in this way a motion in the direction of the dewatering screen openings is forcibly imparted to the pellets or process fluid so that pellets and process fluid are separated from one another in this way. The force component used here can be a centrifugal force component that moves the process fluid centrifugally in an otherwise imparted curved motion. For example, the force component can move the process fluid centrifugally in a spiral motion. The motion imparted on the process fluid by the force component can be enhanced or accelerated by the airflow from the auxiliary blower.

In one or more embodiments, a pre-separation apparatus can be provided for preliminary separation of process fluid and pellets, wherein the pre-separation apparatus has a pre-separator housing and a pre-separator screen with pre-separator screen openings. A construction of this nature is especially compact and can be produced economically.

According to one or more embodiments, the auxiliary blower can be arranged in the region of the pre-separation apparatus in such a manner that the auxiliary airflow therefrom assists in forcing the process fluid through the pre-separator screen openings of the pre-separator screen and blows the pellets with the remaining process fluid further in the direction of the housing from the direction of the pre-separator housing, which can thereby make the apparatus even more effective, since the corresponding flow of air or of a corresponding gas, in particular inert gas such as nitrogen for example, can provide an additional drying and/or transport effect for the pellets or for the coolant and the pellets.

The rotor can be hollow and have, at least in its region upstream in the primary direction of motion of the pellets through the housing, first openings. The first openings can be slit openings. The first openings can allow passage of the auxiliary airflow into the interior of the rotor. The rotor can have, at least in its region downstream in the primary direction of motion of the pellets through the housing, second openings. The second openings can be circular openings. The second openings can allow, for passage of the auxiliary airflow out of the interior of the rotor. The drying performance can be further increased as a result of the additionally imparted auxiliary airflow from the rotor to the dewatering screen or to a pellet outlet of the housing, since the material through put may also be further increased by this means.

The housing can have the inlet for process fluid and pellets in the lower region, and a process fluid outlet in the lower region, and the pellet outlet in the upper region.

In one or more embodiments, at least sections of the dewatering screen can be arranged around the rotor, and the rotor can be located in the region of the screen front, and the housing can be located in the region of the screen rear, and is especially simple and compact in design.

The auxiliary airflow can be controllable, adjustable, or both. For example, the intensity of the auxiliary airflow can be adjustable. The intensity of the auxiliary airflow can be adjusted by controlling the speed of the auxiliary blower, adjusting one or more auxiliary airflow throttle valves in the region of the housing inlet, or combinations thereof.

The apparatus for drying pellets can include an humidity measuring device. The humidity measuring device can measure humidity. The humidity measuring device can be in the region of the pellet outlet.

The apparatus for drying pellets can also include a regulating device. The regulating device can regulate the auxiliary airflow as a function of the measurement results from the humidity measuring device. The regulating device can regulate the auxiliary airflow utilizing the control of the auxiliary blower through operating parameters of the auxiliary blower.

To further increase the efficiency of the drying performance of the apparatus, an exhaust fan for process fluid and/or for process fluid atomized in the air can be connectable by means of a connection on the housing. The exhaust fan can increase the quantity of process fluid evaporated/discharged or help in the avoidance of the accumulation of corresponding pellets in the housing.

The invention is described in detail below using the embodiment explained by way of example.

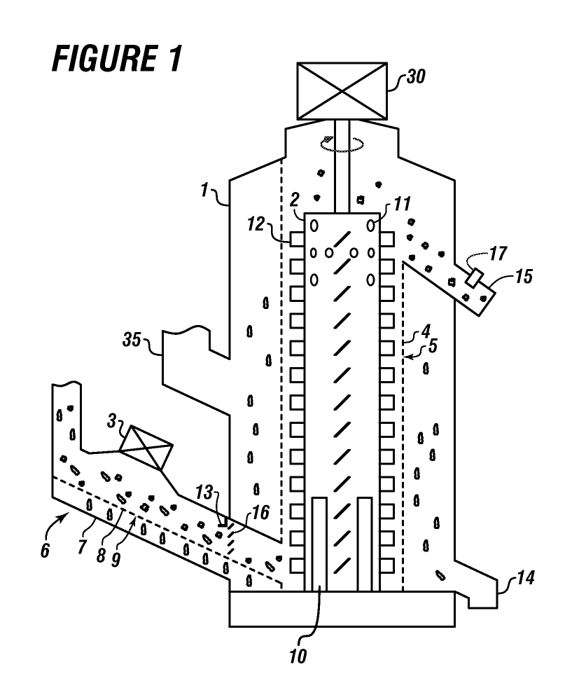

Turning now to the FIGURE, FIG. 1 depicts a schematic longitudinal cross-section of a portion of an apparatus for drying pellets according to an embodiment of the invention.

The apparatus for drying pellets can have a housing 1. A rotor 2 can be disposed within the housing 1.

The rotor 2 can have rotor blades 12. The rotor can be used as a device for impressing motion. The rotor can impress a direction of motion on the pellets and a process fluid that differs locally in each case because of the different centrifugal force components acting thereon. For example, the rotor can generate different inertial forces that can act on the pellets and the process fluid.

The process fluid with the pellets located therein can be delivered to the interior of the housing 1 through a pre-separation apparatus 6 for preliminary separation of process fluid and pellets. The pre-separation apparatus 6 can have a pre-separator housing 7, and a pre-separator screen 8 with pre-separator screen openings 9, which can be located in the pre-separator housing 7.

The process fluid with pellets can traverse through an inlet 13 (at the bottom left in FIG. 1), and thereafter the process fluid with pellets can be moved further upward, for example, in an essentially helical motion, by the rotor 2. The process fluid can be separated from the pellets. For example, the process fluid can be moved radially outside from the pellets in a dewatering region.

The dewatering region can be formed by a dewatering screen 4 with dewatering screen openings 5 that are smaller in size than the pellets, wherein the process fluid is forced outward there by the centrifugal motion and through the dewatering screen openings 5, but the pellets that do not pass through the dewatering screen openings 5, and hence are moved further upward in the housing 1 in a spiral motion, and can be discharged there through a pellet outlet 15 in the upper region of the housing 1.

The process fluid can be discharged from the dewatering region through a process fluid outlet 14 in the lower region of the housing 1.

At least sections of the dewatering screen 4 can be arranged around the rotor 2, wherein the rotor 2 is located in the region of the screen front, and the housing 1 is located in the region of the screen rear.

The rotor 2 is driven by an electric motor 30.

The housing 1 can have a connection 35. The connection can be used to connect an exhaust fan to the housing 1. The exhaust fan can provide additional exhausting from the housing 1 of process fluid and/or of process fluid atomized in the air, which has passed through the dewatering screen openings 5 to the screen rear of the dewatering screen 4. As a result, the relative humidity in the air in the region of the housing 1 can be lowered even further, and the drying performance can be increased accordingly.

An auxiliary blower 3 can be disposed within the housing 1. The auxiliary blower can be configured to provide an auxiliary airflow. The auxiliary airflow can be imparted in the direction of the pellets' primary direction of movement through the housing 1 (helically from the bottom to the top in the housing 1 in FIG. 1). In this design, the auxiliary blower 3 is arranged in the region of the pre-separation apparatus 6 in such a manner that the auxiliary airflow therefrom assists in forcing the process fluid through the pre-separator screen openings 9 of the pre-separator screen 8 and blows the pellets with the remaining process fluid further in the direction of the housing 1 from the direction of the pre-separator housing 7.

The rotor 2 can be hollow. The rotor 2 can have first openings 10. The first openings 10 can be slit openings. The first openings 10 can allow for passage of the auxiliary airflow into the interior of the rotor 2. In addition the rotor 2 can have second openings 11. The second openings can be circular openings 11. The second openings 11 can allow air to exits the interior of the rotor 2.

The auxiliary airflow can be controllable. For example, the intensity of the auxiliary air flow can be adjusted. In addition, the direction of the auxiliary airflow can also be adjusted. The intensity and direction of the auxiliary air flow can be adjusted by a controller (not shown) that can be in communication with the auxiliary blower 3, auxiliary airflow throttle valves 16, or combinations thereof. The auxiliary airflow throttle valves 16 can be arranged in the region of the inlet 13. The auxiliary airflow throttle valves 16 can be pivotable, for example by means of servomotors (not shown in FIG. 1).

A humidity measuring device 17 can be located within the housing 1 in the region of the pellet outlet 15. A regulating device (not show) can be in communicate with the humidity measuring device 17 and regulate the auxiliary airflow as a function of humidity detected by the humidity measuring device and utilizing the control of the auxiliary blower 3 through operating parameters (in particular the speed) of the auxiliary blower 3. The humidity measuring device 17 can realize a non-contacting air humidity measurement which is known per se, for example.

While these embodiments have been described with emphasis on the embodiments, it should be understood that within the scope of the appended claims, the embodiments might be practiced other than as specifically described herein.

What is claimed is:

1. An apparatus for drying pellets comprising:
a. a housing;
b. a rotor, disposed within the housing, wherein the rotor has rotor blades, and wherein the rotor is rotatable;
c. a dewatering region located within the housing
d. at least one dewatering screen within the dewatering region, wherein the dewatering screen comprises at least one screen opening; wherein the at least one screen opening is smaller in size allowing process fluid carrying the pellets to pass therethrough and preventing the pellets from passing therethrough effecting separation of the pellets from the process fluid as the process fluid pass from a screen front to a screen rear, and
e. an auxiliary blower within the housing, wherein the auxiliary blower is configured to provide auxiliary airflow imparted in the direction of the pellets' primary direction of movement through the housing.

2. The apparatus of claim 1, further comprising a pre-separation apparatus for preliminary separation of process fluid and pellets, wherein the pre-separation apparatus has a pre-separator housing and a pre-separator screen, and wherein the pre-separator screen has pre-separator screen openings.

3. The apparatus of claim 2, wherein the auxiliary blower is arranged in the region of the pre-separation apparatus in such a manner that the auxiliary airflow therefrom assists in forcing the process fluid through the pre-separator screen openings and blows the pellets with the remaining process fluid further in the direction of the housing from the direction of the pre-separator housing.

4. The apparatus of claim 1, wherein the rotor is hollow inside and has first openings at least in the rotor's region upstream in the primary direction of motion of the pellets through the housing for passage of the auxiliary airflow into an interior of the rotor, and wherein the rotor has second openings at least in the rotor's region downstream in the primary direction of motion of the pellets through the housing for passage of the auxiliary airflow out of the rotors interior.

5. The apparatus of claim 1, wherein the housing has an inlet for process fluid and pellets in a lower region and a process fluid outlet in the lower region, and wherein the housing has a pellet outlet in an upper region.

6. The apparatus of claim 2, wherein the housing has an inlet for process fluid and pellets in a lower region and a process fluid outlet in the lower region, and wherein the housing has a pellet outlet in an upper region.

7. The apparatus of claim 3, wherein the housing has an inlet for process fluid and pellets in a lower region and a process fluid outlet in the lower region, and wherein the housing has a pellet outlet in an upper region.

8. The apparatus of claim 4, wherein the housing has an inlet for process fluid and pellets in a lower region and a process fluid outlet in the lower region, and wherein the housing has a pellet outlet in an upper region.

9. The apparatus of claim 1, wherein at least sections of the dewatering screen are arranged around the rotor, and wherein the rotor is located in a region of the screen front.

10. The apparatus of claim 2, wherein at least sections of the dewatering screen are arranged around the rotor, and wherein the rotor is located in a region of the screen front.

11. The apparatus of claim 3, wherein at least sections of the dewatering screen are arranged around the rotor, and wherein the rotor is located in a region of the screen front.

12. The apparatus of claim 4, wherein at least sections of the dewatering screen are arranged around the rotor, and wherein the rotor is located in a region of the screen front.

13. The apparatus of claim 5, wherein at least sections of the dewatering screen are arranged around the rotor, and wherein the rotor is located in a region of the screen front.

14. The apparatus of claim 1, wherein the auxiliary airflow is controllable to be adjustable, at least in its intensity by a control for the speed of the auxiliary blower, auxiliary airflow throttle valves, or combinations thereof.

15. The apparatus of claim 1, further comprising a humidity measuring device in the region of the pellet outlet

16. The apparatus of claim 15, further comprising a regulating device that regulates the auxiliary airflow as a function of humidity measurement results from the humidity measuring device.

17. The apparatus of claim 1, further comprising a connector on the housing for connecting to an exhaust fan for process fluid, process fluid atomized in the air, or combinations thereof.
